(19) United States
(12) Patent Application Publication
(10) Pub. No.: US 2012/0138215 A1
(43) Pub. Date: Jun. 7, 2012

(54) NANO GLASS POWDER FOR SINTERING ADDITIVE AND METHOD FOR FABRICATING THE SAME

(75) Inventors: Ic Seob KIM, Yongin (KR); Sung Ryong KIM, Seongnam (KR); Soo Hwan SON, Seoul (KR); Jin Woo HAN, Yongin (KR); Sung Yong AN, Anyang (KR)

(73) Assignee: SAMSUNG ELECTRO-MECHANICS CO., LTD.

(21) Appl. No.: 13/162,283

(22) Filed: Jun. 16, 2011

(30) Foreign Application Priority Data
Dec. 3, 2010 (KR) 10-2010-0122733

(51) Int. Cl. C03C 3/089; C03B 8/00; C03B 19/10; C03C 12/00; B32B 38/14; B82Y 30/00

(52) U.S. Cl. 156/182; 428/402; 501/12; 65/17.2; 977/775

(57) ABSTRACT

There are provided a nano glass powder for a sintering additive and a method for fabricating the same. The method for fabricating the nano glass powder for the sintering additive includes fabricating a mixed solution by dissolving a raw material of boron (B), a raw material of silicon (Si), and a raw material of a metal oxide in a non-aqueous solvent; controlling a sol-gel reaction by adding an alkali catalyst to the mixed solution, drying a sol-gel material obtained by the sol-gel reaction, and heat treating the sol-gel material.

### CROSS-REFERENCE TO RELATED APPLICATIONS

This application claims the priority of Korean Patent Application No. 10-2010-0122733 filed on Dec. 3, 2010, in the Korean Intellectual Property Office, the disclosure of which is incorporated herein by reference.

### BACKGROUND OF THE INVENTION

1. Field of the Invention

The present invention relates to a nano glass powder for a sintering additive and a method for fabricating the same, and more particularly, to a method for fabricating a nano glass powder for low-temperature sintering, capable of fabricating the nano glass powder using a sol-gel method and a nano glass powder for a sintering additive fabricated using the same.

2. Description of the Related Art

Recently, as the market for mobile communications devices such as a mobile phones has developed, the demand of ceramics as a material of a multilayer ceramic electronic component for use therein has increased. A ceramic material which can be fired at a low temperature is required as a material of an internal wiring circuit while having a low melting point and a high conductive material such as Ag, Cu, or the like.

In general, in the case of a dielectric ceramic component for low-temperature firing, such as a multilayer ceramic capacitor, a glass powder is used as a sintering additive for sintering a dielectric material requiring a high firing temperature at a low temperature.

Currently, the glass powder is mainly composed as a ternary or more system and the ternary or more glass powder is fabricated by a melting method.

In a known method for fabricating the glass powder, first, glass materials are prepared. K₂O (or KOH), B₂O₃ (or H₃BO₃), and SiO₂ as the glass materials are prepared and measured, respectively.

Next, the materials are melted at a temperature of about 1500□ or more and then the melted materials are rapidly cooled.

Thereafter, the rapid-cooled materials are ground by milling to be fabricated into a final glass powder. As such, the fabricated glass powder may be composed of K₂O-bB₂O₃-cSiO₂.

The fabricated glass powder is used as a sintering agent of a dielectric, a dielectric thick film is fabricated using a dielectric powder and the glass powder, and an internal electrode is then printed thereon. Thereafter, the dielectric ceramic component for low-temperature firing, such as the multilayer ceramic capacitor, is fabricated through compressing, cutting, and firing processes.

Herein, when the glass powder is fabricated by a known method, since a high-temperature glass melt should be extracted, the processing thereof is difficult and risk increases. In addition, when raw materials are melted at a high temperature, a composition deviation may occur due to the volatilization of a component such as a trace of metal oxide and the glass powder fabricated by the melting method becomes particulate, while small particles drop due to the break of edges of the particles during a grinding process, to thereby be ground into irregular forms in a fine grinding process, making it impossible to control a particle shape.

In addition, when the powder is fabricated by a physical method such as milling, it is difficult to decrease a particle size to about 1.0 μm or less, due to a strong hardness of the glass and a particle distribution thereof being non-uniform.

Therefore, in order to fabricate a passive element reduced in size, a dielectric green sheet is required to be thinned, and for this, particles of the dielectric powder and the glass powder for the sintering additive need to be small.

However, the glass powder is difficult to particulate by known melting methods. Accordingly, in order to thin the dielectric sheet, various attempts are being made to make the particle size of the glass powder minute, and furthermore, nano-sized.

### SUMMARY OF THE INVENTION

An aspect of the present invention provides a method for fabricating a nano glass powder for low-temperature sintering, capable of fabricating the nano glass powder having a uniform particle distribution using a sol-gel method, and a nano glass powder fabricated using the same.

According to an aspect of the present invention, there is provided a method for fabricating a nano glass powder for a sintering additive including: fabricating a mixed solution by dissolving a raw material of boron (B), a raw material of silicon (Si), and a raw material of a metal oxide in anon-aqueous solvent; controlling a sol-gel reaction by adding an alkali catalyst to the mixed solution; drying a sol-gel material obtained by the sol-gel reaction; and heat treating the sol-gel material.

The non-aqueous solvent may be ethanol.

The heat-treating may be performed at a temperature of 650° C. or less.

A glass powder having a particle size of 100 nm or more may be fabricated using the non-aqueous solvent.

According to another aspect of the present invention, there is provided a method for fabricating a nano glass powder for a sintering additive including: fabricating a mixed solution by dissolving a raw material of boron (B), a raw material of silicon (Si), and a raw material of a metal oxide in an aqueous solvent; controlling a sol-gel reaction by adding an alkali catalyst to the mixed solution; and drying a sol-gel material obtained by the sol-gel reaction.

The aqueous solvent may be water.

In the dissolving of the raw materials in the aqueous solvent, an acidic solution may be further added in order to increase a solubility of the raw materials.

The glass powder having a particle size of 100 nm or more may be fabricated using the aqueous solvent.

The raw material of a metal oxide may be a hydroxide-based material.

The raw material of a metal oxide may be a monovalent metal oxide.

The drying of the sol-gel material may be performed at a temperature of 70° C. or more.

The alkali catalyst may be one or more selected from the group consisting of ammonia (NH₄OH), ethanol (EtOH), urea (NH₂CONH₂), ethylamine, and butylamine-based materials.

The size of the glass powder particle may be adjusted by controlling one or more of a kind of the solvent, the amount of the catalyst, a sol-gel reaction temperature, and a solubility of the raw material.

The nano glass powder particle may have a spherical shape.

The nano glass powder may have a composition of aSiO₂+bB₂O₃+cM₂O, wherein the M is a metal, and the a, b, and c are a+b+c=1 and may satisfy mole fractions of 0.75≦a<1, 0<b≦0.23, and 0<c≦0.02.

According to yet another aspect of the present invention, there is provided a nano glass powder for a sintering additive fabricated by a sol-gel method and having a composition of aSiO₂+bB₂O₃+cM₂O, wherein the M is a metal, and the a, b, and c are a+b+c=1 and may satisfy mole fractions of 0.75≦a<1, 0<b≦0.23, and 0<c≦0.02.

The mole fraction ‘a’ of the SiO₂ may be 0.9 or more.

The M₂O may be a monovalent metal oxide.

The glass powder particle may have a spherical shape.

The glass powder particle may have a particle-diameter of 1.0 μm or less.

According to still yet another aspect of the present invention, there is provided a method for fabricating a ceramic electronic component for a sintering additive including: forming a plurality of green sheets by mixing the nano glass powder for a sintering additive fabricated by one of the above-described methods with a dielectric powder; forming a plurality of conductive patterns on the plurality of green sheets; and forming a multilayer body by stacking the plurality of green sheets having the conductive patterns.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a flowchart illustrating a method for fabricating a nano glass powder according to a first exemplary embodiment of the present invention.

FIGS. 2A and 2B are images showing a nano glass powder fabricated according to the first exemplary embodiment of the present invention.

FIG. 3 is a flowchart illustrating a method for fabricating a nano glass powder according to a second exemplary embodiment of the present invention.

FIG. 4 is an image of a nano glass powder fabricated according to the second exemplary embodiment of the present invention.

### DETAILED DESCRIPTION OF THE PREFERRED EMBODIMENT

Hereinafter, exemplary embodiments of the present invention will be described in detail with reference to the accompanying drawings. However, the exemplary embodiments of the present invention may be modified into various forms and the scope of the present invention is not limited to the exemplary embodiments to be described below.

Further, the exemplary embodiments of the present invention are provided so that those skilled in the art may more completely understand the present invention. Accordingly, shapes and sizes of components in figures may be exaggerated for a clearer description and like reference numerals refer to like elements in the accompanying drawings.

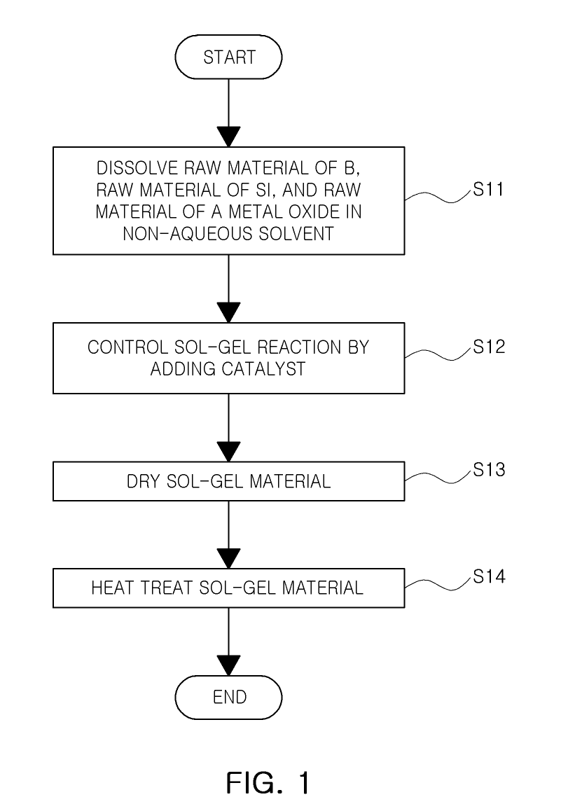

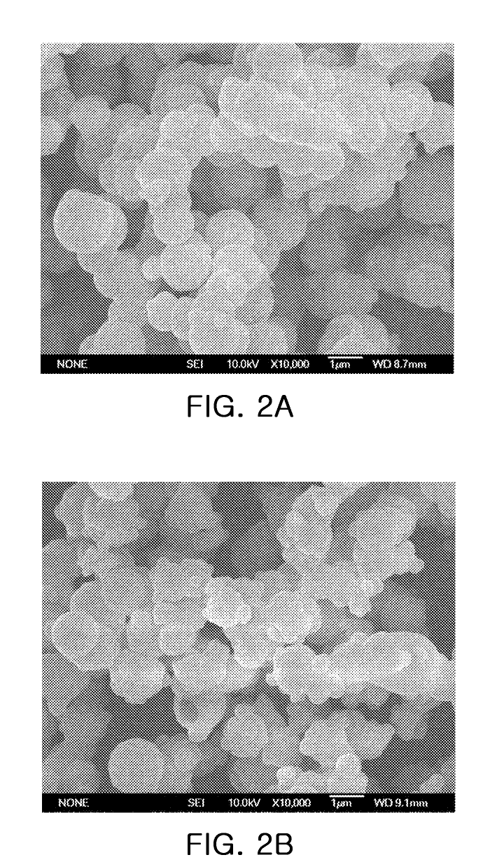

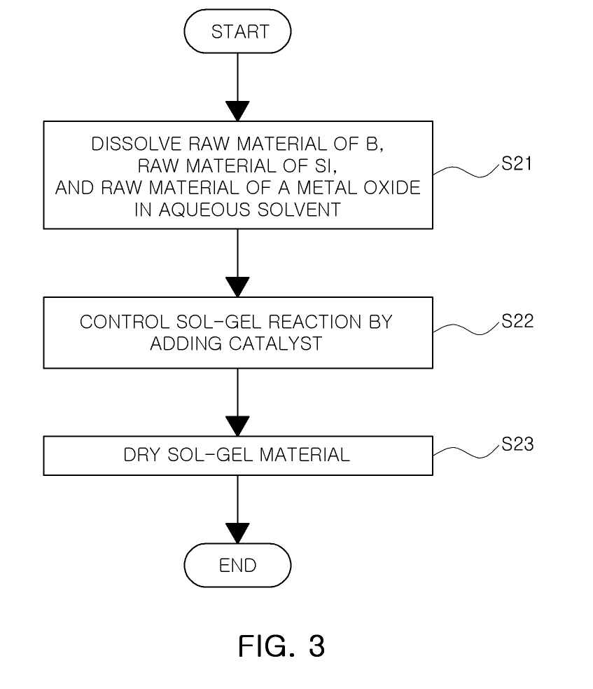

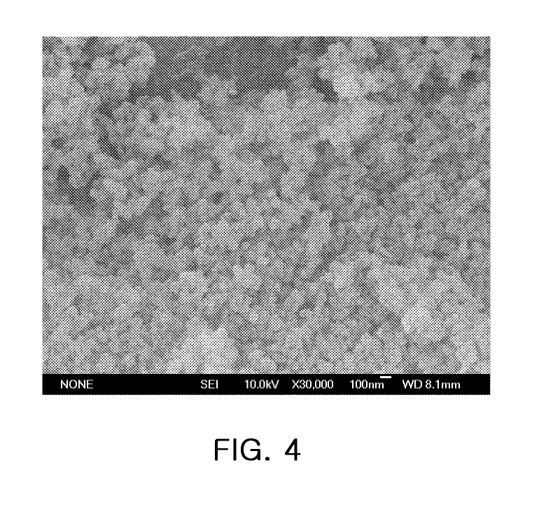

FIG. 1 is a flowchart illustrating a method for fabricating a nano glass powder according to a first exemplary embodiment of the present invention, FIGS. 2A and 2B are images showing a nano glass powder fabricated according to the first exemplary embodiment of the present invention, FIG. 3 is a flowchart illustrating a method for fabricating a nano glass powder according to a second exemplary embodiment of the present invention, and FIG. 4 is an image showing a nano glass powder fabricated according to the second exemplary embodiment of the present invention.

Referring to FIG. 1, the method for fabricating the nano glass powder according to the first exemplary embodiment of the present invention includes fabricating a mixed solution by dissolving a raw material of boron (B), a raw material of silicon (Si), and a raw material of a metal oxide in a non-aqueous solvent (S11); controlling a sol-gel reaction by adding an alkali catalyst to the mixed solution (S12); drying a sol-gel material obtained by the sol-gel reaction (S13); and heat-treating the sol-gel material (S14).

Finally, in order to fabricate the nano glass powder for the sintering additive having a final composition of aSiO₂+bB₂O₃+cM₂O, the raw material of boron (B), the raw material of silicon (Si), and the raw material of a metal oxide may be dissolved in the non-aqueous solvent (S11).

Herein, the M is a metal, the a, b, and c are a+b+c=1 and may be the glass powder satisfying mole fractions of 0.75≦a<1, 0<b≦0.23, and 0<c≦0.02.

The raw material of boron (B) may be boric acid or trimethyl borate.

The raw material of silicon (Si) may use an alkoxide-based material and particularly, may use tetraethyl orthosilicate (TEOS).

The M₂O is the raw material of a metal oxide and the M is a metal. The M is a monovalent metal oxide and may use a hydroxide-based material. However, it is not limited thereto and M may be K⁺, Na⁺, or the like.

The mixed material of the raw material of boron (B), the raw material of silicon (Si), and the raw material of a metal oxide having the composition as described above may be dissolved in the non-aqueous solvent.

It is possible to control the concentration of the raw material by adjusting the amounts of the mixed material and the non-aqueous solvent and to control the size of the nano glass powder particles depending on the amount of the included raw material.

The non-aqueous solvent may be ethanol as a basic material, but is not limited thereto and may use various non-aqueous solvents in dissolving the raw materials.

After the mixed material is dissolved in the non-aqueous solvent, the alkali catalyst may be added so as to induce the sol-gel reaction (S12).

The alkali catalyst functions to initiate and activate the sol-gel reaction and may control a size and a shape of the finally generated glass powder by adjusting the pH of the mixed solution, depending on the amount of the alkali catalyst.

The alkali catalyst may use one or more selected from the group consisting of ammonia (NH₄OH), ethanol (EtOH), urea (NH₂CONH₂), ethylamine, and butylamine-based materials and particularly, may use a mixture of the ammonia and the ethanol.

A temperature of a reactor may be controlled so as to adjust the sol-gel reaction. That is, the alkali catalyst may be added in the reactor by rapidly stirring the mixed solution in a state in which the temperature of the reactor is controlled. In addition, conversely, the mixed solution may be added in the reactor by stirring the alkali catalyst.

The reaction temperature of the mixed solution may be increased until all the mixed raw materials have undergone the sol-gel reaction. Accordingly, all the raw materials may undergo the sol-gel reaction without residues. In particular, when residues exist in the final reactant, they may function as impurities, impairing the purity of the nano glass powder. Accordingly, the sol-gel reaction may be induced such that the residues do not remain.

After the sol-gel reaction is completed, the reactant is dried or filtered to be separated from the solvent (S13).

After the sol-gel reaction is completed, the reactant may be dried at a temperature of approximately 70° C. or more and the sol-gel material may be in a dry cake state by removing the solvent to allow only the reactant to remain.

In addition, the sol-gel material may be ground by further adding a ball mill process, to thereby make it possible to fabricate the nano glass powder for the sintering additive.

The dried nano glass powder may be heat-treated at a temperature of 650° C. or less (S14).

An organic solvent included in the sol-gel material fabricated through the sol-gel reaction may be fully removed through the heat treating process.

FIGS. 2A and 2B are photographs showing a nano glass powder fabricated by a sol-gel reaction using a non-aqueous solvent.

Referring to FIGS. 2A and 2B, the nano glass powder fabricated by dissolving a raw material of boron (B), a raw material of silicon (Si), and a raw material of a metal oxide in the non-aqueous solvent to induce the sol-gel reaction. That is, the nano glass powder from which the solvent has been removed is illustrated.

The glass powder may have a particle size of 100 nm to 1.0 μm. Since the glass powder is not fabricated through a physical grinding process after melting large glass powder particles, a polishing surface or an abrasion surface shown in the physical grinding process is not shown.

That is, since the glass powder is fabricated by a chemical synthesis process, the glass powder may have a roughly spherical shape and may have a smooth surface.

In addition, since the glass powder is fabricated by the chemical synthesis, the size of the glass powder may be adjusted by controlling one or more of the amount of the catalyst, a sol-gel reaction temperature, a solubility of the raw material.

In addition, since an amorphous glass powder composed of the ternary or more components may be synthesized by using a low-priced hydroxide-based metal oxide as the raw material of the glass powder, it is possible to reduce the manufacturing costs.

The method for fabricating the nano glass powder according to the second exemplary embodiment of the present invention includes fabricating a mixed solution by dissolving a raw material of boron (B), a raw material of silicon (Si), and a raw material of a metal oxide in an aqueous solvent (S21); controlling a sol-gel reaction by adding an alkali catalyst to the mixed solution (S22); and drying a sol-gel material obtained by the sol-gel reaction (S23).

In order to fabricate the nano glass powder for the sintering additive having a final composition of aSiO₂+bB₂O₃+cM₂O, the raw material of boron (B), the raw material of silicon (Si), and the raw material of a metal oxide may be dissolved in the aqueous solvent (S21).

Herein, the M is a metal, the a, b, and c are a+b+c=1 and may satisfy mole fractions of 0.75≦a<1, 0<b≦0.23, and 0<c≦0.02.

The raw material of boron (B) may be boric acid or trimethyl borate.

The raw material of silicon (Si) may use an alkoxide-based material and particularly, may use tetraethyl orthosilicate (TEOS).

The M₂O is the raw material of a metal oxide and the M is a metal. The M is a monovalent metal oxide and may use a hydroxide-based material. However, it is not limited thereto and the M may be K⁺, Na⁺, or the like.

The mixed material of the raw material of boron (B), the raw material of silicon (Si), and the raw material of a metal oxide having the composition as described above may be dissolved in the aqueous solvent.

It is possible to control the concentration of the raw material by adjusting the amounts of the mixed material and the aqueous solvent and to control the size of the nano glass powder particles depending on the amount of the included raw material.

The aqueous solvent may be water as a basic material, but is not limited thereto and may use various aqueous solvents dissolving the raw materials.

In addition, an acidic solution may be further added in order to dissolve the raw material of boron (B), the raw material of silicon (Si), and the raw material of a metal oxide in the aqueous solvent. In the case of the raw material of silicon (Si), the acidic solution may be further added in order to increase the solubility for the aqueous solvent.

After the mixed material is dissolved in the aqueous solvent, the alkali catalyst may be added so as to induce the sol-gel reaction (S22).

The alkali catalyst functions to initiate and activate the sol-gel reaction and may control the size and the shape of the finally generated glass powder by adjusting the pH of the mixed solution, depending on the amount of the alkali catalyst.

As the alkali catalyst, one or more selected from the group consisting of ammonia (NH₄OH), ethanol (EtOH), urea (NH₂CONH₂), ethylamine, and butylamine-based materials may be used and particularly, a mixture of the ammonia and the ethanol may be used.

A temperature of a reactor may be controlled so as to adjust the sol-gel reaction. That is, the alkali catalyst may be added in the reactor by rapidly stirring the mixed solution in a state where the temperature of the reactor is controlled. In addition, conversely, the mixed solution may be added in the reactor by stirring the alkali catalyst.

The reaction temperature of the mixed solution may be increased until all the mixed raw materials have undergone the sol-gel reaction. Accordingly, all the raw materials may undergo the sol-gel reaction without residues. In particular, when the residues exist in the final reactant, they may act as impurities, impairing the purity of the nano glass powder. Accordingly, the sol-gel reaction may be induced so as to prevent the residues from remaining.

After the sol-gel reaction is completed, the reactant may be dried or filtered to be separated from the solvent (S23).

After the sol-gel reaction is completed, the reactant may be dried at a temperature of 70 to 150° C. and the sol-gel material may be in a dry cake state by removing the solvent to allow only the reactant to remain.

In addition, the sol-gel material may be ground by further adding a ball mill process, thereby fabricating the nano glass powder for the sintering additive.

When various raw materials and the raw material of a metal oxide are dissolved using the aqueous solvent, the heat treating process may be not performed, unlike in the case of the synthesis of the glass powder using the non-aqueous solvent.

The glass powder particle fabricated using the aqueous solvent may have a particle-diameter of 100 nm or less and the solvent may be fully removed through the heat treating process at a temperature of 70 to 150° C.

Accordingly, the nano glass powder may be fabricated through only the drying process at a temperature of 70° C. or more.

FIG. 4 is an image of a nano glass powder for low-temperature sintering fabricated by dissolving a raw material of boron (B), a raw material of silicon (Si), and a raw material of a metal oxide in an aqueous solvent to induce a sol-gel reaction.

The glass powder particle fabricated using the aqueous solvent may have a size of 100 nm or less. The glass powder may have a minute size because the glass powder is fabricated through not a physical grinding process after melting but a chemical synthesis.

In addition, a ground surface or an abrasion surface shown in the physical grinding process is not formed and the glass powder has a smooth spherical shape.

In the exemplary embodiment of the present invention, since an amorphous glass powder composed of the ternary or more components is fabricated by using a low-priced hydroxide-based material as the raw material of metal oxide, it is possible to fabricate the nano glass powder at a low cost.

The nano glass powder fabricated according to the exemplary embodiment of the present invention has a composition of aSiO₂+bB₂O₃+cM₂O, herein, the M is a metal, the a, b, and c are a+b+c=1 and may satisfy mole fractions of 0.75≦a<1, 0<b≦0.23, and 0<c≦0.02.

Preferably, the mole fraction ‘a’ of SiO₂ may be 0.9 or more. That is, a high purity of the glass powder where SiO₂ is equal to or more than 90% may be fabricated. This is because the high purity of the glass powder can be synthesized by adjusting the amount of the raw material of silicon (Si) when the mixed material is formed by mixing the raw material of boron (B), the raw material of silicon (Si), and the raw material of metal oxide.

In particular, the M may be a monovalent metal oxide and the hydroxide-based material may be used as the raw material. Particularly, since the hydroxide-based material is the low-priced metal oxide, it is possible to reduce an entire manufacturing cost.

In addition, since the nano glass powder for low-temperature sintering is fabricated not through the physical grinding process, but the chemical synthesis method by the sol-gel reaction, it is possible to fabricate the glass powder particles having various sizes such as 1.0 μm or less.

That is, the nano glass powder according to the exemplary embodiment of the present invention may not have the ground surface or the abrasion surface shown in the physical grinding process and may have a smooth spherical shape. In addition, the size of the glass powder may be adjusted by controlling one or more of a kind of the solvent, the amount of the catalyst, a sol-gel reaction temperature, and a solubility of the raw material.

The nano glass powder for the sintering additive fabricated according to the first or the second exemplary embodiments of the present invention may be used to fabricate green sheets by being mixed with dielectric powder. It is possible to form a ceramic electronic component by fabricating a plurality of green sheets, forming a plurality of conductive patterns on the green sheets, and stacking and sintering the green sheets having the conductive patterns formed thereon.

According to the exemplary embodiment of the present invention, since the nano glass powder for the sintering additive is fabricated by the chemical synthesis method, it is possible to prevent the contamination of the mixed material caused by contacting the mixed material with an alumina ball or a zirconia ball used as a grinding medium in the physical grinding process.

That is, since the nano glass powder is fabricated by the chemical synthesis method, it is possible to fabricate the high purity of the nano glass powder without separate impurities.

In particular, as the purity of SiO₂ is increased in the glass powder, the glass powder should be melted at a high temperature. Particularly, when the SiO₂ of 90% or more is included, the glass powder should be melted at a temperature of 1600□ or more.

However, in the present invention, although the SiO₂ of 90% or more is included, the nano glass powder can be synthesized by the sol-gel synthesis method at a low temperature.

Since the size of the nano glass powder particles may be adjusted by controlling one or more of the kind of the solvent, the amount of the catalyst, the sol-gel reaction temperature, and the solubility of the raw material, it is possible to fabricate the glass powder having various sizes of 1.0 μm or less.

In addition, according to the exemplary embodiment of the present invention, since high-temperature melting of 1500□ or more, rapid cooling, and grinding processes are not required, unlike in the related art, it is possible to further stabilize and simplify the manufacturing process of the nano glass powder.

That is, in the case of the non-aqueous solvent, only the heat treating process needs to be performed at a temperature of 650° C. or less, while in the case of the aqueous solvent, only the drying process needs to be performed at a temperature of 70 to 150° C. Thus, expensive melting equipment and grinding equipment does not need to be used, thereby reducing manufacturing costs.

Since the nano glass powder fabricated according to the exemplary embodiment of the present invention may have a minute particle-size, it is suitable to be applied to a compact product. Particularly, since the spherical glass powder particle is used in manufacturing the green sheet, it is possible to fabricate a chip without the deformation of a thick printed electrode.

Further, when a thin film green sheet is fabricated using the nano glass powder, a film density can be improved due to the particulate size and the round shape of the glass powder. Accordingly, it is possible to suppress an interlayer short defect. In addition, the deformation of the printed electrode can be minimized by improving the flow resistance of particles in a matrix of a binder which is an additive giving compactability of the green sheet at the time of compression of the green sheet and accordingly, the green sheet can be prevented from being dented.

### Inventive Example 1

Tetraethyl silicate as a raw material of silicon (Si), boric acid as a raw material of boron (B), and potassium hydroxide as a raw material of a metal oxide were used.

The raw materials were weighed so as to have a mole ratio of silicon:boron:metal of 20:4:1 in the tetraethyl silicate, the boric acid, and the potassium hydroxide, and dissolved in ethanol which is a non-aqueous solvent.

Thereafter, a mixture of ammonia and ethanol was added to induce a sol-gel reaction. In addition, a sol-gel material obtained by the sol-gel reaction was dried at a temperature of 70° C. and heat-treated at a temperature of 650° C. for five hours to fully remove the solvent.

The glass powder fabricated by the method mentioned above had a size of 250 nm and a spherical shape.

In addition, the fabricated glass powder had a composition of aSiO₂+bB₂O₃+cK₂O and mole fractions which were a of 0.81, b of 0.17, and c of 0.02.

### Inventive Example 2

Tetraethyl silicate as a raw material of silicon (Si), boric acid as a raw material of boron (B), and potassium hydroxide as a raw material of a metal oxide were used.

The raw materials were weighed so as to have a mole ratio of silicon:boron:metal of 20:4:1 in the tetraethyl silicate, the boric acid, and the potassium hydroxide and dissolved in water which is an aqueous solvent.

At this time, acetic acid as an acidic solution was further added in order to increase the solubility of water, and a sol-gel reaction was induced by adding an alkali catalyst solution. In addition, a sol-gel material obtained by the sol-gel reaction was dried at a temperature of 70° C.

The glass powder fabricated by the method mentioned above had a size of 100 nm and a spherical shape.

In addition, the fabricated glass powder had a composition of aSiO₂+bB₂O₃+cK₂O and mole fractions which were a of 0.81, b of 0.17, and c of 0.02.

As set forth above, according to various exemplary embodiments of the present invention, it is possible to fabricate a nano glass powder having a nano size and a uniform particle-size distribution, such that a dielectric sheet can be thinned.

According to various exemplary embodiments of the present invention, since a sol-gel process is performed at a low temperature, the processing thereof is easy and the stability of the processing is increased. In addition, since a nano glass powder is fabricated at a low temperature, impurities other than components of metal oxide are not mixed therewith, such that composition deviation does not occur. Further, since a particle is chemically synthesized by a sol-gel method, the shape of the particle can be easily controlled and a glass particle having a center diameter of 1.0 μm or less can be easily fabricated.

While the present invention has been shown and described in connection with the exemplary embodiments, it will be apparent to those skilled in the art that modifications and variations can be made without departing from the spirit and scope of the invention as defined by the appended claims. Accordingly, the scope of the present invention will be determined by the appended claims.

What is claimed is:

1. A method for fabricating a nano glass powder for a sintering additive, the method comprising:
fabricating a mixed solution by dissolving a raw material of boron (B), a raw material of silicon (Si), and a raw material of a metal oxide in a non-aqueous solvent;
controlling a sol-gel reaction by adding an alkali catalyst to the mixed solution;
drying a sol-gel material obtained by the sol-gel reaction; and
heat-treating the sol-gel material.

2. The method of claim 1, wherein the non-aqueous solvent is ethanol.

3. The method of claim 1, wherein the heat-treating is performed at a temperature of 650° C. or less.

4. The method of claim 1, wherein the glass powder having a particle size of 100 nm or more is fabricated using the non-aqueous solvent.

5. A method for fabricating a nano glass powder for a sintering additive, the method comprising:
fabricating a mixed solution by dissolving a raw material of boron (B), a raw material of silicon (Si), and a raw material of a metal oxide in an aqueous solvent;
controlling a sol-gel reaction by adding an alkali catalyst to the mixed solution; and
drying a sol-gel material obtained by the sol-gel reaction.

6. The method of claim 5, wherein the aqueous solvent is water.

7. The method of claim 5, wherein in the dissolving of the raw materials in the aqueous solvent, an acidic solution is further added in order to increase solubility of the raw materials.

8. The method of claim 5, wherein the glass powder having a size of 100 nm or less is fabricated using the aqueous solvent.

9. The method of claim 1 or 5, wherein the raw material of a metal oxide includes a monovalent metal oxide.

10. The method of claim 9, wherein the raw material of a metal oxide is a hydroxide-based material.

11. The method of claim 1 or 5, wherein the drying of the sol-gel material is performed at a temperature of 70° C. or more.

12. The method of claim 1 or 5, wherein the alkali catalyst is one or more selected from the group consisting of ammonia (NH₄OH), ethanol (EtOH), urea (NH₂CONH₂), ethylamine, and butylamine-based materials.

13. The method of claim 1 or 5, wherein the size of the glass powder is adjusted by controlling one or more of a kind of the solvent, the amount of the catalyst, a sol-gel reaction temperature, and a solubility of the raw material.

14. The method of claim 1 or 5, wherein the nano glass powder has a spherical shape.

15. The method of claim 1 or 5, wherein the nano glass powder has a composition of aSiO₂+bB₂O₃+cM₂O, wherein the M is a metal, and the a, b, and c are a+b+c=1 and satisfy mole fractions of 0.75≦a<1, 0<b≦0.23, and 0<c≦0.02.

16. A nano glass powder for a sintering additive, wherein the nano glass powder is fabricated by the method of claim 1 or 5 and has a composition of aSiO₂+bB₂O₃+cM₂O, wherein the M is a metal, and the a, b, and c are a+b+c=1 and satisfy mole fractions of 0.75≦a<1, 0<b≦0.23, and 0<c≦0.02.

17. The powder of claim 16, wherein the mole fraction ‘a’ of the SiO₂ is 0.9 or more.

18. The powder of claim 16, wherein the M is a monovalent metal oxide.

19. The powder of claim 16, wherein the glass powder particle has a spherical shape.

20. The powder of claim 16, wherein the glass powder has a particle-diameter of 1.0 μm or less.

21. A method for fabricating a ceramic electronic component for a sintering additive, the method comprising:
forming a plurality of green sheets by mixing the nano glass powder for a sintering additive fabricated by the method of claim 1 or 5 with a dielectric powder;
forming a plurality of conductive patterns on the plurality of green sheets; and
forming a multilayer body by stacking the plurality of green sheets having the conductive patterns.
